(19) United States
(12) Patent Application Publication
(10) Pub. No.: US 2005/0028945 A1
(43) Pub. Date: Feb. 10, 2005

(54) Sealing cover for upper beam of blinds

(75) Inventor: Ben Hsu, Changhua Hsien (TW)

Correspondence Address: TROXELL LAW OFFICE PLLC;SUITE 1404, 5205 LEESBURG PIKE, FALLS CHURCH, VA, 22041, US

(73) Assignee: Ching Feng Blinds Ind. Co., Ltd.

(21) Appl. No.: 10/633,492

(22) Filed: Aug. 5, 2003

(51) Int. Cl. E06B 9/30

(52) U.S. Cl. 160/178.1 R

(57) ABSTRACT

A sealing cover for the upper beam of blinds is made up of a blind, a sealing cover, and a decoration piece wherein the blind has an upper beam, and a blind embodiment of a Venetian blind, a fabric drapery, a bamboo shade, a Roman blind, or a folding blind, etc. attached to the bottom of the upper beam thereof. The sealing cover has a coupling section disposed at one side to be engaged with a coupling hole disposed at both ends of the upper beam respectively. The other side of the sealing cover is disposed a dovetail fixing block with a stop flange extending transversely at the bottom thereof to which a dovetail fixing groove disposed at one side of the decoration piece is led from the top to bottom till abutted against the bottom stop flange thereof, securely locating the decoration piece onto the upper beam thereof. A decoration article attached at the other side of the decoration piece can be variously changed in a do-it-yourself manner matching to the blind embodiment of different types, increasing the unique texture and the visual beauty of the blinds in display as well as boosting the competitive power of the blinds thereof in the market.

### BACKGROUND OF THE INVENTION

The present invention is related to a sealing cover for the upper beam of blinds, comprising a blind, a sealing cover, and a decoration piece wherein the blind is made up of an upper beam and a blind embodiment attached to the bottom of the upper beam thereof. The sealing cover has a coupling section disposed at one side thereof to be engaged with a coupling hole disposed at both ends of the upper beam thereof respectively, and a dovetail fixing block with a bottom stop flange protruding at the other side thereof to be joined to a dovetail fixing groove of the decoration piece thereof; whereby, via the sealing cover thereof, the decoration piece with a decoration article of various designs and styles attached at the other side thereof can be securely located onto the upper beam thereof in an easy and fast manner, increasing the unique texture and the visual beauty of the blinds in display as well as boosting the competitive power of the blinds thereof in the market.

Please refer to FIG. 1. A conventional sealing cover for the upper beam of blinds is made up of a blind 10 having an upper beam 11 and a blind body 12 of a Venetian blind, a fabric drapery, a bamboo shade, a Roman blind, or a folding blind, etc. attached to the bottom of the upper beam 11 thereof. A transversely T-shaped cover 13 is sleeve joined at both ends of the upper beam 11 therein respectively via a coupling section 131 disposed at one side of the T-shaped cover 13 thereof.

There are some disadvantages to such conventional sealing cover for the upper beam of blinds. Most of all, the Venetian blind 10 is simply made for the purpose of shading with the transversely T-shaped sealing cover 13 plainly adapted at both ends of the upper beam 11 thereof respectively without any other articles applied thereon for decoration. Thus, it's both monotonously boring in visual effect and cheap in textural value, which makes it rather uncompetitive in the market.

### SUMMARY OF THE PRESENT INVENTION

It is, therefore, the primary purpose of the present invention to provide a sealing cover for the upper beam of blinds, comprising a blind, a sealing cover, and a decoration piece wherein the blind is made up of an upper beam, and a blind embodiment attached to the bottom of the upper beam thereof. The sealing cover has a coupling section disposed at one side thereof to be engaged with a coupling hole disposed at both ends of the upper beam thereof respectively, and a dovetail fixing block protruding at the other side thereof to be joined to a dovetail fixing groove of the decoration piece thereof; whereby, via the sealing cover thereof, the decoration piece with a decoration article of various designs and styles attached at the other side thereof can be securely located onto the upper beam thereof in a do-it-yourself manner to match the blind embodiment of different types, increasing the unique texture and the visual beauty of the blinds in display as well as boosting the competitive power of the blinds thereof in the market.

It is, therefore, the secondary purpose of the present invention to provide a sealing cover for the upper beam of blinds wherein the dovetail fixing groove of the decoration piece is in sleeve engagement with the dovetail fixing block of the sealing cover from the top to the bottom till abutted against a stop flange extending transversely at the bottom thereof for secure location thereon, facilitating the assembly of the present invention in an easy and fast manner.

### BRIEF DESCRIPTION OF THE DRAWINGS

FIG. 1 is a perspective exploded view of a conventional sealing cover for the upper beam of blinds.

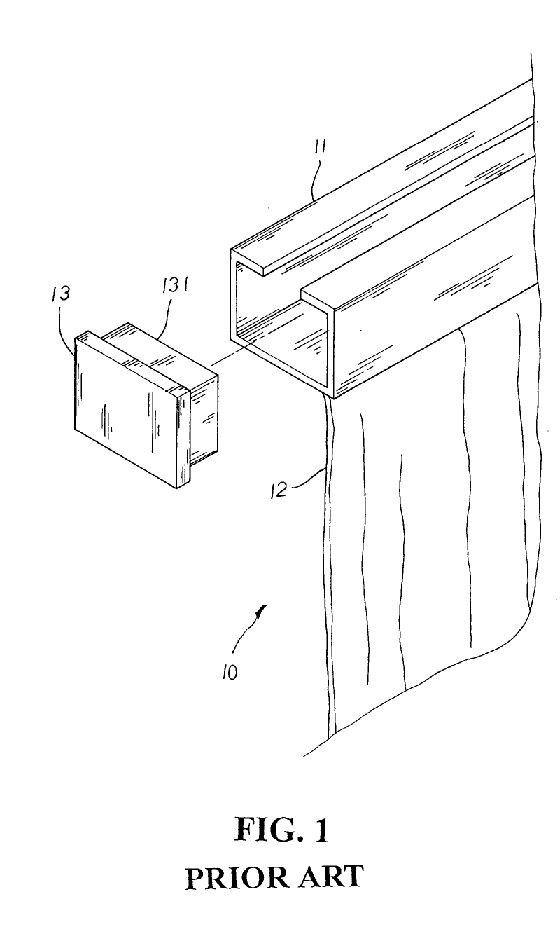

FIG. 2 is a perspective exploded view of the present invention.

FIG. 3 is a perspective view of the present invention in assembly.

FIG. 4 is a perspective exploded view of another embodiment of the present invention.

### DETAILED DESCRIPTION OF THE PREFERRED EMBODIMENTS

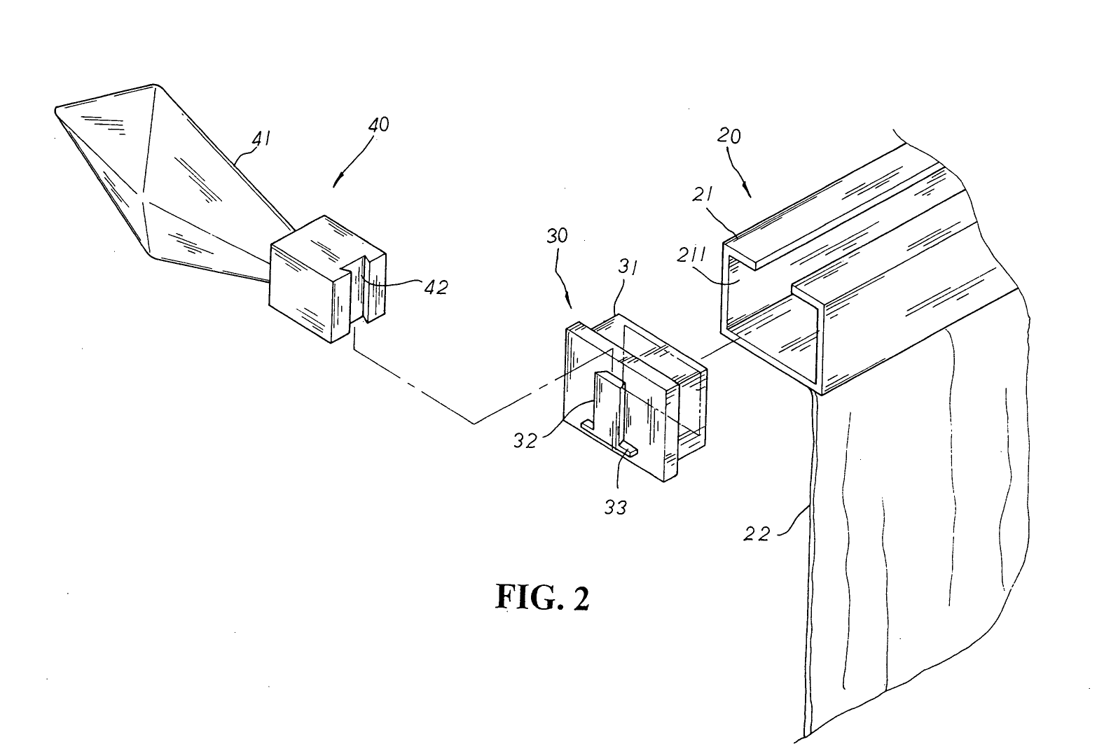

Please refer to FIG. 2. The present invention is related to a sealing cover for the upper beam of blinds, comprising a blind 20, a sealing cover 30, and a decoration piece 40. The blind 20 is made up of an upper beam 21 having a coupling hole 211 defining at both ends thereof respectively, and a blind embodiment 22 of a Venetian blind, a fabric drapery, a bamboo shade, a Roman blind, or a folding blind, etc. attached to the bottom of the upper beam 21 thereof. The sealing cover 30 is integrally molded, having a hollow coupling section 31 disposed at one side thereof matching the coupling hole 211 of the upper beam 21 for sleeve engagement therewith, a dovetail fixing block 32 protruding at the middle of the other side thereof, and a stop flange 33 extending transversely at the bottom of the dovetail fixing block 32 thereof. The decoration piece 40, integrally molded, is equipped with a decoration article 4 of various designs and styles attached at one side thereof, and a dovetail fixing groove 42 defining the other side thereof.

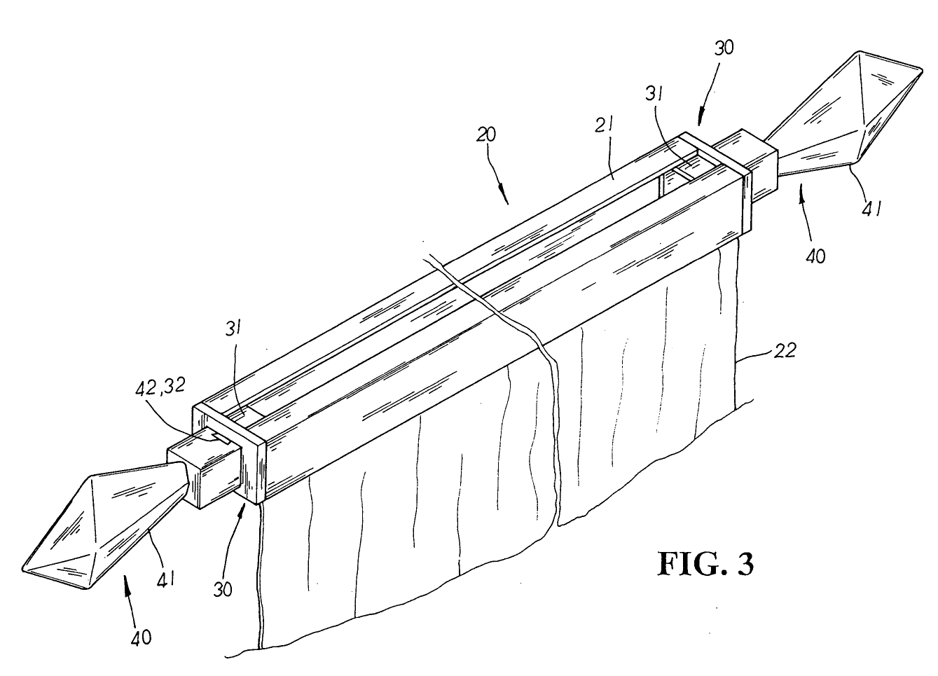

Please refer to FIG. 3. In assembly, the coupling section 31 of the sealing cover 30 is joined to the coupling hole 211 of the upper beam 21 and securely located thereon. The dovetail fixing groove 42 of the decoration piece 40 is led from the top to the bottom to be engaged with the dovetail fixing block 32 of the sealing cover 30 till abutted against the bottom stop flange 33 thereof, securely locating the decoration piece 40 to the sealing cover 30 thereon. Meanwhile, the decoration article 41 attached at one side of the decoration piece 40 thereof can be variously and easily changed in a do-it-yourself manner matching to the blind embodiment 20 of different types, increasing the unique texture and the visual beauty of the blinds in display as well as boosting the competitive power of the blinds thereof in the market.

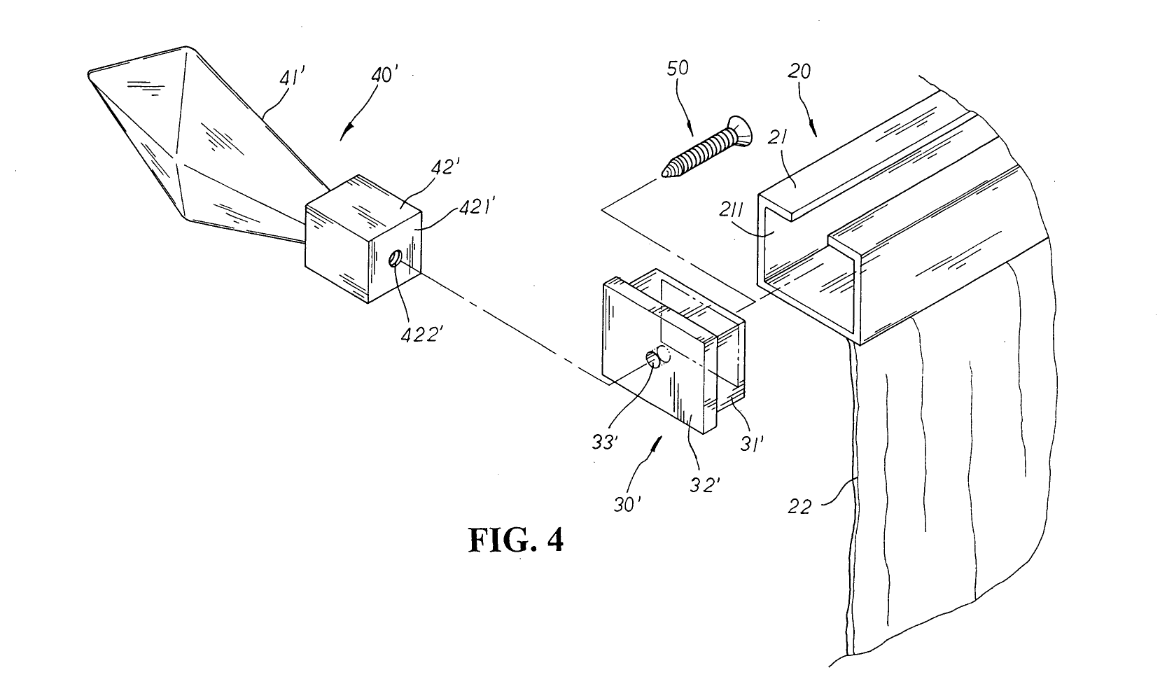

Please refer to FIG. 4. The sealing cover for the upper beam of blinds can also have a sealing cover 30′ with a plane abutting facet 32′ disposed at one side thereof, and a decoration piece 40′ with a decoration article 41′ and a fixing block 42′ attached at one side of the decoration article 41′ thereof. The center of the plane abutting facet 32′ thereof is disposed a fixing hole 33′ communicating with a hollow coupling section 31′ disposed at the other side of the sealing cover 30′ thereof. The fixing block 42′ thereof has a plane fixing facet 421′ with a screw hole 422′ thereon disposed at one side thereof. In assembly, the plane fixing facet 421′ of the fixing block 42′ thereof is abutted against the plane abutting facet 32′ of the sealing cover 30′ and located thereto via a screw 50 led through the fixing hole 33′ from the hollow coupling section 31′ thereof and securely joined to the screw hole 422′ of the fixing block 42′ thereof for location thereof. The coupling section 31′ of the sealing cover 30′ is then adapted to the coupling hole 211 of the upper beam 21 therein and fixedly joined thereto in sleeve engagement to complete the assembly thereof.

1. A sealing cover for the upper beam of blinds, comprising a blind, a sealing cover, and a decoration piece wherein the blind is made up of an upper beam, and a blind embodiment of a Venetian blind, a fabric drapery, a bamboo shade, a Roman blind, or a folding blind, etc. attached to the bottom of the upper beam thereof; both ends of the upper beam have a coupling hole defined thereon respectively to be engaged with a coupling section disposed at one side the sealing cover thereof; the present invention being characterized by that,
the other side of the sealing cover having a dovetail fixing block protruding at the middle thereof, and a stop flange extending transversely at the bottom of the dovetail fixing block thereof;
the decoration piece having a decoration article of various designs and styles attached at one side thereof, and a dovetail fixing groove defining the other side thereof to be engaged with the dovetail fixing block of the sealing cover;
in assembly, the coupling section of the sealing cover is joined to the coupling hole of the upper beam in sleeve engagement and the dovetail fixing groove of the decoration piece led from the top to the bottom to be engaged with the dovetail fixing block of the sealing cover till abutted against the bottom stop flange thereof for secure location thereon; meanwhile, the decoration article thereof can be variously and easily changed in a do-it-yourself manner matching to the blind embodiment of different types, increasing the unique texture and the visual beauty of the blinds in display as well as boosting the competitive power of the blinds thereof in the market.

2. The sealing cover for the upper beam of blinds as claimed in claim 1 wherein the fixing block of the sealing cover can be dovetailed in shape.

3. The sealing cover for the upper beam of blinds as claimed in claim 1 wherein the fixing groove of the decoration piece thereof can be dovetailed in shape matching to the dovetail fixing block of the sealing cover for secure engagement thereof.

4. The sealing cover for the upper beam of blinds as claimed in claim 1 wherein both the sealing cover and the decoration piece thereof are integrally molded.

5. The sealing cover for the upper beam of blinds as claimed in claim 1 wherein one side of the sealing cover can also be provided with a plane abutting facet having a fixing hole disposed at the center thereof communicating with the hollow coupling section of the sealing cover thereof, and one side of the decoration piece can also has a fixing block with a plane fixing facet and a screw hole disposed thereon to be abutted against the plane abutting facet of the sealing cover and located thereto via a screw led through the fixing hole from the hollow coupling section thereof and securely joined to the screw hole of the fixing block thereof; the coupling section of the sealing cover is then adapted to the coupling hole of the upper beam and securely located thereto in sleeve engagement.
